(19) United States
(12) Patent Application Publication
(10) Pub. No.: US 2026/0267092 A1
(43) Pub. Date: Sep. 10, 2026

(54) TRANSMITTER STRUCTURE AND SILICON PHOTONICS MODULE

(71) Applicant: ACCELIGHT TECHNOLOGIES (WUHAN) CO., LTD., Wuhan (CN)

(72) Inventors: Gong-En GU, Wuhan (CN); Michael Xiaoyan WEI, Wuhan (CN); William STERLING, Wuhan (CN); Meirong ZHANG, Wuhan (CN); Zhen YANG, Wuhan (CN); Shu SHANG, Wuhan (CN); Liuyin YANG, Wuhan (CN); Jiangming XU, Wuhan (CN)

(73) Assignee: ACCELIGHT TECHNOLOGIES (WUHAN) CO., LTD., Wuhan (CN)

(21) Appl. No.: 19/660,681

(22) Filed: Apr. 28, 2026

(30) Foreign Application Priority Data
Feb. 28, 2025 (CN) 202520348561.4

(51) Int. Cl. G02B 6/42

(52) U.S. Cl. CPC G02B 6/4214

(57) ABSTRACT

A transmitter structure includes a silicon photonics chip. The silicon photonics chip includes at least one input waveguide. An optical input unit is correspondingly arranged upstream of an optical path of each input waveguide. A central optical axis of the optical input unit and a central optical axis of the input waveguide are arranged in a non-collinear layout. An optical redirecting device is arranged between the optical input unit and the silicon photonics chip, and the optical redirecting device is configured to receive a laser beam from the optical input unit and redirect the laser beam to the input waveguide. By arranging the optical redirecting device at the input waveguide of the silicon photonics chip, the present disclosure achieves deflection of a coupling optical path, thereby completing mode field matching with the input waveguide of the silicon photonics chip and effectively reducing coupling loss.

### CROSS-REFERENCE TO RELATED APPLICATIONS

This application claims priority to Chinese Patent Application No. 202520348561.4, filed on February 28, 2025, which is hereby incorporated by reference in its entirety.

### TECHNICAL FIELD

The present disclosure relates to a transmitter structure, belonging to the field of silicon photonics module technologies, and in particular, relates to a transmitter structure and a silicon photonics module.

### BACKGROUND

With a rapid development of information technologies, demand for data transmission in fields such as telecommunications, big data, and cloud computing is trending towards high speed and large capacity. Against this background, demand for high-speed optical modules, as a key component for data transmission, has increased dramatically. Currently, a widely adopted solution in the industry is a multi-channel parallel solution based on an Electro-Absorption Modulated Laser (EML). However, this solution has many problems such as large space occupation, high device power consumption, and complex coupling processes, which severely restrict its application in future high-speed optical communication fields.

The present disclosure aims to provide a transmitter structure and a silicon photonics module, which overcomes technical defects existing in the related art. By arranging an optical redirecting device at an input waveguide of a silicon photonics chip, deflection of a coupling optical path is achieved, thereby completing mode field matching with the input waveguide of the silicon photonics chip and effectively reducing coupling loss.

The present disclosure discloses a transmitter structure, including a silicon photonics chip, where the silicon photonics chip includes at least one input waveguide, an optical input unit is correspondingly arranged upstream of an optical path of each input waveguide, and a central optical axis of the optical input unit and a central optical axis of the input waveguide are arranged in a collinear layout.

The present disclosure also discloses a transmitter structure, including a silicon photonics chip, where the silicon photonics chip includes at least one input waveguide, an optical input unit is correspondingly arranged upstream of an optical path of each input waveguide, a central optical axis of the optical input unit and a central optical axis of the input waveguide are arranged in a non-collinear layout, an optical redirecting device is arranged between the optical input unit and the silicon photonics chip, and the optical redirecting device is configured to receive a laser beam from the optical input unit and redirect the laser beam to the input waveguide.

In a preferred embodiment of the present disclosure, the optical redirecting device is an optical prism or an optical mirror.

In a preferred embodiment of the present disclosure, the optical prism includes an incident surface facing the optical input unit and an exit surface facing the input waveguide, and the incident surface and the exit surface are arranged non-parallel to each other.

In a preferred embodiment of the present disclosure, the optical input unit includes a laser assembly, a collimating lens, an isolator, and a focusing lens that are arranged in sequence, or the optical input unit comprises a laser assembly, a collimating lens, a focusing lens, and an isolator that are arranged in sequence.

In a preferred embodiment of the present disclosure, the transmitter structure further includes a first structural component, an end of the first structural component is provided with an isolator mounting position, another end of the first structural component is provided with a focusing lens mounting position, the isolator mounting position and the focusing lens mounting position are interconnected, the isolator is mounted in the isolator mounting position, and the focusing lens is mounted in the focusing lens mounting position.

In a preferred embodiment of the present disclosure, the transmitter structure further includes a second structural component, an end of the second structural component is provided with a focusing lens mounting position, another end of the second structural component is provided with an optical prism mounting position, the optical prism mounting position and the focusing lens mounting position are interconnected, the focusing lens is mounted in the focusing lens mounting position, and the optical prism is mounted in the optical prism mounting position.

In a preferred embodiment of the present disclosure, the central optical axis of the optical input unit is parallel to a long side of the silicon photonics chip, or an angle exists between the central optical axis of the optical input unit and a long side of the silicon photonics chip.

In a preferred embodiment of the present disclosure, the silicon photonics chip further includes at least one output waveguide, and a fiber array is correspondingly arranged downstream of an optical path of the output waveguide.

The present disclosure also discloses a silicon photonics module, which includes the above transmitter structure.

The beneficial effects produced by the present disclosure are as follows. By arranging a prism at the input waveguide of the silicon photonics chip, the present disclosure achieves deflection of a coupling optical path, thereby completing mode field matching with the input waveguide of the silicon photonics chip and effectively reducing coupling loss. Therefore, the present disclosure effectively realizes beam splitting and modulation of a coupled beam, reduces a quantity of components in the laser assembly, effectively reduces space occupation of optical components, coupling complexity and power consumption of optical components, enhances reliability of optical components, and optimizes a Printed Circuit Board Assembly (PCBA) layout space required by the optical module. After the present disclosure is adopted, a need to design special-shaped PCBA is eliminated.

Firstly, by arranging the optical redirecting device between the optical input unit and the silicon photonics chip, the present disclosure allows the central optical axis of the optical input unit and the central optical axis of the input waveguide to be arranged in a non-collinear layout, thereby breaking through a limitation in a traditional optical path design that requires strict coaxial alignment between a light source and a waveguide. This design significantly improves arrangement flexibility of the optical input unit and provides a larger design space for optimizing a device structure.

Secondly, the present disclosure adopts the optical prism or the optical mirror as the optical redirecting device, which can efficiently redirect the laser beam emitted by the optical input unit and precisely couple the laser beam into the input waveguide of the silicon photonics chip. This optical path design not only ensures high-quality transmission of the laser beam but also effectively reduces the coupling loss at the optical input port, thereby improving optical efficiency of a system.

Thirdly, when a scheme with the optical prism is adopted, by designing a structure where the incident surface and the exit surface are arranged non-parallel to each other, a propagation direction of the laser beam may be flexibly adjusted to achieve an optimal incident angle, thereby further optimizing coupling efficiency of the laser beam. This structural design also facilitates precise alignment and adjustment during a manufacturing process.

Furthermore, the optical input unit of the present disclosure adopts a modular design of the laser assembly, the collimating lens, the isolator, and the focusing lens. The optical components are arranged coaxially in sequence, which not only ensures high-quality transmission of the laser beam, but also realizes standardized assembly of a device, thereby contributing to improved production efficiency and product yield.

Again, by designing dedicated first and second structural components, the present disclosure provides stable mounting structures for the isolator, the focusing lens, and the optical prism. This structural design not only ensures precise positioning of each optical component, but also facilitates assembly and maintenance of a device, and improves mechanical stability of an entire transmitter structure.

Furthermore, in a design of the laser assembly, by aligning a light-emitting end of a light-emitting ridge of a laser with an end surface of a heat sink and aligning a photosensitive surface of a backlight detector with the light-emitting ridge, efficient heat dissipation and precise monitoring of a device are achieved, thereby helping to improve operational stability and reliability of the laser.

In summary, an overall design of the present disclosure balances optical performance and engineering practicality. The functional components adopt a modular design, thereby facilitating mass production and integration. At the same time, a device assembly process of this design scheme is relatively simple, which helps reduce production cost and improve product competitiveness.

### BRIEF DESCRIPTION OF THE DRAWINGS

The present disclosure will be further described below with reference to the accompanying drawings and embodiments.

FIG. 1 is a schematic structural diagram of an embodiment according to the present disclosure.

FIG. 2 is a schematic structural diagram of an embodiment according to the present disclosure.

FIG. 3 is a schematic structural diagram of an embodiment according to the present disclosure.

FIG. 4 is a schematic structural diagram of an embodiment according to the present disclosure.

FIG. 5 is a schematic structural diagram of an embodiment according to the present disclosure.

FIG. 6 is a schematic structural diagram of an embodiment according to the present disclosure.

FIG. 7 is a schematic structural diagram of an embodiment according to the present disclosure.

FIG. 8 is a schematic structural diagram of an embodiment according to the present disclosure.

### DETAILED DESCRIPTION OF THE EMBODIMENTS

To make objectives, technical solutions, and advantages of the present disclosure clearer, the present disclosure is further described in detail below with reference to the accompanying drawings and embodiments. It should be understood that the specific embodiments described herein are only used to explain the present disclosure and are not intended to limit it.

In the description of the present disclosure, it should be understood that orientations or positional relationships indicated by terms such as "center", "longitudinal", "transverse", "length", "width", "thickness", "upper", "lower", "front", "rear", "left", "right", "vertical", "horizontal", "top", "bottom", "inner", "outer", "clockwise", "counterclockwise", "axial", "radial", and "circumferential" are orientations or positional relationships shown in the accompanying drawings. They are only for the convenience of describing the present disclosure and simplifying the description, and do not indicate or imply that the referred device or component must have a specific orientation or be constructed and operated in a specific orientation. Therefore, they should not be construed as limiting the present disclosure.

Furthermore, the terms "first" and "second" are used for descriptive purposes only and cannot be understood as indicating or implying relative importance or implicitly indicating the quantity of the indicated technical features. Thus, features defined with "first" and "second" may explicitly or implicitly include at least one of the features. In the description of the present disclosure, "a plurality of" means at least two, such as two, or three, unless otherwise explicitly and specifically limited.

In the present disclosure, unless otherwise explicitly specified and limited, terms such as "mount", "connect", "interconnect", and "fix" should be understood broadly. For example, it may be a fixed connection, a detachable connection, or an integral connection; it may be a mechanical connection, or an electrical connection; it may be a direct connection, or an indirect connection through an intermediate medium; and it may be an interconnection between two components or an interaction relationship between two components, unless otherwise explicitly limited. For those of ordinary skill in the art, the specific meanings of the above terms in the present disclosure may be understood according to specific circumstances.

As a new solution, silicon photonics modules based on silicon photonics technologies have emerged. The silicon photonics modules have significant advantages such as high speed, high integration, high reliability, and low power consumption, providing a new technical path for the development of high-speed optical modules. However, silicon photonics chips still face several technical challenges in practical applications, the most prominent of which is coupling loss at an optical input port.

A main cause of the coupling loss at the optical input port is significant mismatching between a silicon-based optical waveguide and a mode field of an optical fiber. Due to a high refractive index of a silicon material (n≈3.5), a lateral dimension of the silicon-based optical waveguides is typically only a few hundred nanometers, while a mode field diameter of standard single-mode fibers reaches 8-10 micrometers. This huge difference in mode field dimension leads to significant mode mismatch loss when an optical signal couples from a fiber into a silicon-based optical waveguide. Even with coupling structures commonly used today, such as grating couplers or inverted taper waveguides, the coupling loss at the optical input port typically remains above 3 dB, and in some cases, may even exceed 5 dB.

This relatively large coupling loss not only reduces overall optical efficiency of silicon photonics chips, but also leads to degraded signal quality and increases difficulty of subsequent photoelectric signal processing. At the same time, a presence of the coupling loss also imposes higher requirements on chip temperature control, as excessive loss is converted into heat, thereby affecting stability and reliability of a device. Furthermore, relatively large coupling loss also reduces power budget of a system, limits transmission distance, and ultimately affects performance of an entire optical communication system.

Therefore, how to effectively reduce the coupling loss at the optical input port of the silicon photonics chips has become one of the key technical problems urgently needing to be solved in the current field of silicon photonics technologies.

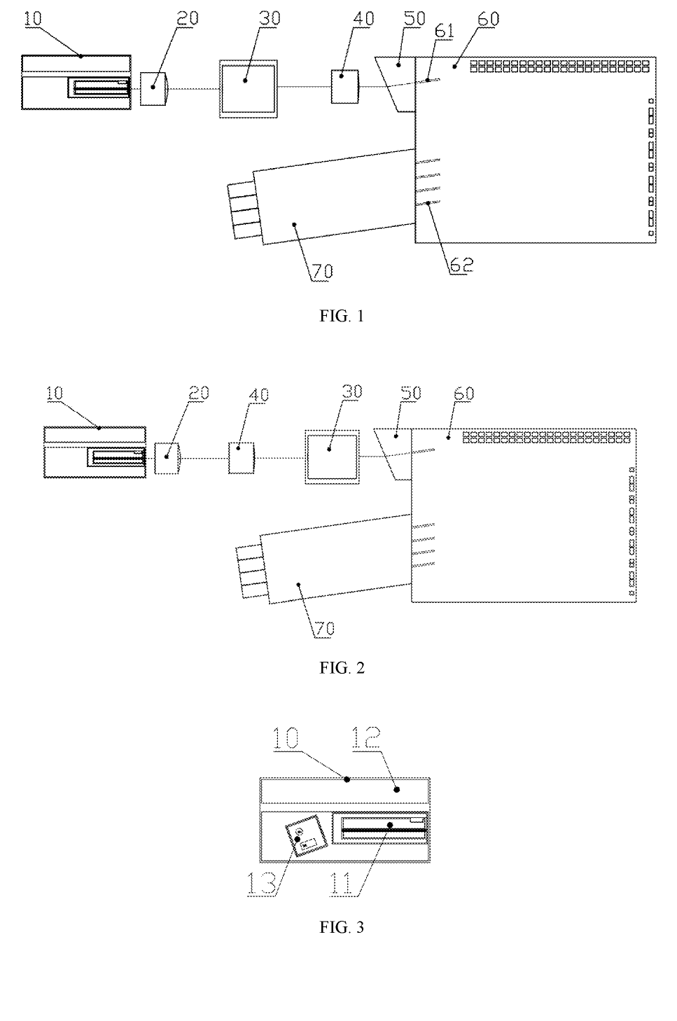

In a specific embodiment of the present disclosure, as shown in FIG. 1, a transmitter structure for a silicon photonics module includes a laser assembly 10, a collimating lens 20, an isolator 30, a focusing lens 40, an optical prism 50, a silicon photonics chip 60, and a fiber array 70 that are arranged in sequence along an optical path. The collimating lens 20 is mainly used to collimate a laser beam emitted from the laser assembly 10, thereby enabling the beam to propagate as parallel light. Subsequently, the beam undergoes unidirectional transmission control through the isolator 30, and this structure may effectively improve resistance of the assembly to back-reflection. After the beam passes through the isolator 30, the collimated laser beam is converged by the focusing lens 40 to achieve effective coupling with a subsequent optical path.

It is worth noting that the present disclosure adopts a special optical path design scheme. Specifically, an optical system is composed of the laser assembly 10, the collimating lens 20, the isolator 30, and the focusing lens 40, and a preset angular deviation is provided between an optical axis of the optical system and a central axis of an input waveguide 61 of the silicon photonics chip 60. The optical axis is parallel to a long side of the silicon photonics chip 60. A purpose of this non-collinear design is to effectively reduce an impact of reflected light from a coupling end surface on the system.

To achieve precise redirecting of the above optical path, the optical prism 50 is arranged between the focusing lens 40 and the input waveguide 61 of the silicon photonics chip 60. The optical prism 50 has a right trapezoid structure and includes an incident surface facing an optical input unit and an exit surface facing the input waveguide 61. The incident surface of the optical prism 50 is precisely aligned with the emitted beam of the laser, and the exit surface of the optical prism 50 is kept aligned with the input waveguide 61 of the silicon photonics chip 60. This design not only achieves effective optical path redirecting, but, more importantly, enables good mode field matching between the emitted beam of the laser and the input waveguide 61 of the silicon photonics chip 60, thereby significantly reducing an influence of the reflected light.

Inside the silicon photonics chip 60, functional structures such as the input waveguide 61, a beam splitter, a modulator, and an output waveguide 62 are arranged in sequence along a direction of light propagation. It should be specifically noted that a quantity of ports at the output waveguide 62 of the silicon photonics chip 60 may be flexibly configured according to actual application requirements and is not limited to the quantity shown in FIG. 1; and the output waveguide 62 may be expanded to 1×N output ports. Correspondingly, the fiber array 70, arranged at the output waveguide 62 of the silicon photonics chip 60, may also be configured with a corresponding quantity of receiving ports, and the fiber array 70 also supports 1×N expanded configuration, which is not limited to the 1×4 structure shown in FIG. 1.

Through the above technical solution, the present disclosure not only solves a problem of reflected light interference in a traditional transmitter structure, but also provides an expandable modular design scheme with good engineering application value.

As shown in FIG. 2, an embodiment provides the transmitter structure for the silicon photonics module. An arrangement sequence of optical components is altered, particularly a position of the isolator 30. Specifically, the transmitter structure in this embodiment includes the laser assembly 10, the collimating lens 20, the focusing lens 40, the isolator 30, the optical prism 50, the silicon photonics chip 60, and the fiber array 70 that are arranged sequentially along an optical path.

In terms of optical path design, the collimating lens 20 still performs a function of collimating the emitted beam of the laser, thereby forming parallel light. The subsequent focusing lens 40 is configured to converge the collimated laser beam to achieve better laser beam control. The isolator 30, disposed after the focusing lens 40, ensures a unidirectional transmission characteristic of the beam, thereby effectively enhancing resistance of the assembly to back-reflection.

This embodiment also adopts a non-collinear optical path design strategy. Specifically, an optical system is composed of the laser assembly 10, the collimating lens 20, the focusing lens 40, and the isolator 30, and a preset angular deviation is also provided between an optical axis of the optical system and a central axis of the input waveguide 61 of the silicon photonics chip 60. The optical axis is parallel to a long side of the silicon photonics chip 60. This design similarly aims to reduce an influence of reflected light from a coupling end surface.

To achieve precise redirecting of the optical path, the optical prism 50 is disposed between the isolator 30 and the input waveguide 61 of the silicon photonics chip 60. An incident surface of the optical prism 50 is precisely aligned with the emitted beam of the isolator 30, and an exit surface of the optical prism 50 maintains good alignment with the input waveguide 61 of the silicon photonics chip 60. This configuration not only achieves effective optical path redirecting, but also achieves mode field matching between the emitted beam of the laser and the input waveguide 61 of the silicon photonics chip 60, thereby significantly reducing an influence of reflected light.

An internal structure of the silicon photonics chip 60 remains unchanged, with functional units such as the input waveguide 61, a beam splitter, a modulator, and an output waveguide 62 that are arranged sequentially along a direction of light propagation. It should be noted that a quantity of ports at the output waveguide 62 of the silicon photonics chip 60 has good scalability and is not limited to the quantity shown in the figure; and the output waveguide 62 may be configured as 1×N output ports according to actual needs. Correspondingly, the fiber array 70, disposed at the output waveguide 62 of the silicon photonics chip 60, may also be configured with a corresponding quantity of receiving ports, and the fiber array 70 also supports 1×N expanded configuration, which is not limited to the illustrated 1×4 structure.

This embodiment provides another optional solution for the system design by adjusting the arrangement sequence of the optical components, especially by placing the isolator 30 after the focusing lens 40, thereby offering greater design flexibility for different application scenarios and ensuring basic functionality.

As shown in FIG. 3, an embodiment mainly discloses an improved structure of the laser assembly 10 in the transmitter structure for the silicon photonics module. The laser assembly 10 mainly includes three main parts: a laser 11, a heat sink 12, and a backlight detector 13. Performance and reliability of a device are improved through an optimized structural design.

In terms of structural arrangement, the laser 11 is disposed on the heat sink 12. It is particularly noteworthy that a light-emitting end of a light-emitting ridge of the laser 11 is aligned with a right end surface of the heat sink 12. This precise alignment design not only helps improve output quality of a laser beam, but, more importantly, ensures effective heat conduction, thereby enhancing heat dissipation of a device.

In terms of monitoring design, the backlight detector 13 is ingeniously disposed on a backlight side of the light-emitting ridge of the laser 11. It is worth noting that an accurate alignment design is adopted between a photosensitive surface of the backlight detector 13 and the light-emitting ridge of the laser 11. In particular, as shown in FIG. 3, to further optimize system performance, a certain angular deviation may be provided between a central axis of the photosensitive surface of the backlight detector 13 and the light-emitting ridge of the laser 11. This non-orthogonal design concept is mainly to effectively reduce an interference impact of reflected light on a system.

Through the above structural design, this embodiment not only achieves stable operation and effective heat dissipation of the laser, but also realizes real-time monitoring of optical power through the ingenious arrangement of the backlight detector, thereby providing important guarantees for reliable operation of a system. At the same time, by introducing a design concept of the angular deviation, anti-interference capability of a system is further enhanced. This improved structure of the laser assembly may be used in conjunction with other optical components described in above embodiments to jointly form the transmitter structure for the silicon photonics module with superior performance.

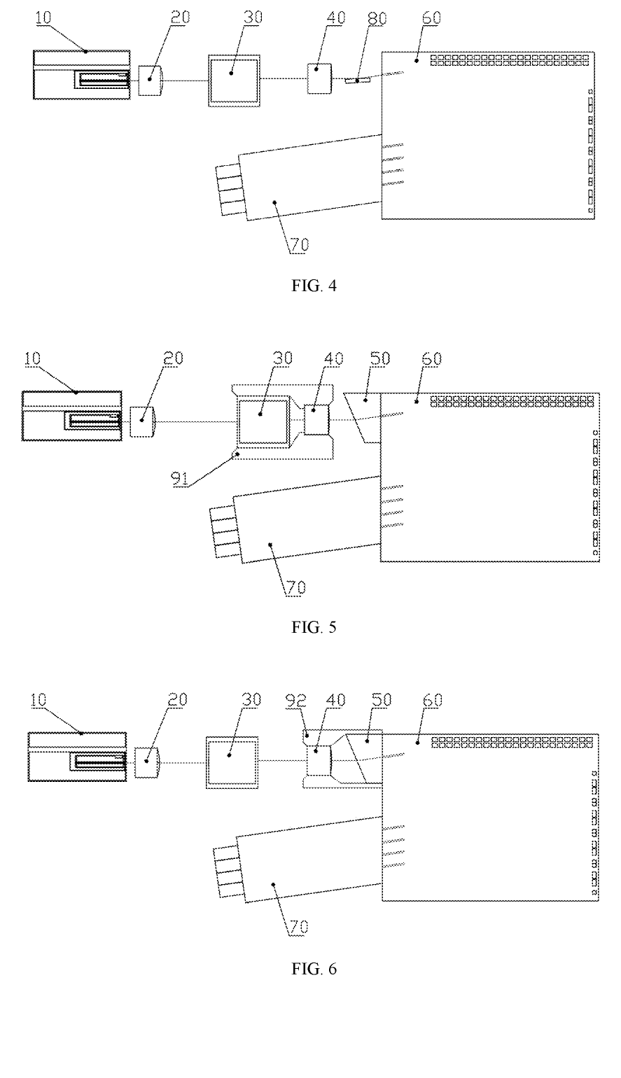

As shown in FIG. 4, an embodiment provides an improved structure of the transmitter structure for the silicon photonics module. On the basis of maintaining the overall optical path design concept, this embodiment innovatively adopts an optical mirror 80 to replace the optical prism 50 in the above embodiments, providing a new technical solution for optical path redirecting.

In terms of specific structure, the transmitter structure in this embodiment still includes the laser assembly 10, the collimating lens 20, the isolator 30, the focusing lens 40, the silicon photonics chip 60, and the fiber array 70 that are arranged sequentially along an optical path. An optical system from the laser assembly 10 to the focusing lens 40 maintains a certain preset angular deviation from an input waveguide 61 of the silicon photonics chip 60. This non-collinear design effectively reduces an influence of reflected light from a coupling end surface.

A core innovation of this embodiment lies in adopting the optical mirror 80 as the optical redirecting device. This optical mirror 80 is disposed between the focusing lens 40 and the input waveguide 61 of the silicon photonics chip 60, with its specific position and angle precisely designed and adjusted. A reflective surface of the optical mirror 80 is treated with a high-reflectivity coating, thereby ensuring efficient reflection of a laser beam. An incident surface of the optical mirror 80 faces the emitted beam of the focusing lens 40, and a reflective surface of the optical mirror 80 is arranged at a specific angle, so that the reflected beam can be precisely aligned with the input waveguide 61 of the silicon photonics chip 60.

In terms of optical path design, the optical mirror 80 is required not only to achieve beam direction redirecting, but, more importantly, to ensure good mode field matching between the redirected beam and the input waveguide 61 of the silicon photonics chip 60. For this purpose, a mounting structure of the optical mirror 80 is designed with a precise angle adjustment mechanism, allowing fine-tuning during assembly to achieve optimal coupling performance.

Compared to the optical prism 50 used in the above embodiments, the optical mirror 80 has following advantages.

Firstly, the structure is simple, and only one reflective surface is required to achieve optical path redirecting, thereby reducing a quantity of optical interfaces.

Secondly, the assembly process is relatively simple, and adjustment flexibility is relatively large.

Thirdly, the cost is relatively low, and economic advantages are significant, especially in mass production.

Fourthly, reflection efficiency is high, and the reflection efficiency may be further improved by optimizing a coating process.

In terms of the silicon photonics chip 60, an internal structure of the silicon photonics chip 60 remains unchanged, and still includes functional units such as the input waveguide 61, a beam splitter, a modulator, and an output waveguide 62 that are arranged sequentially along an optical path. Similarly, a quantity of ports at the output waveguide 62 of the silicon photonics chip 60 may be flexibly configured as 1×N output ports according to actual needs. Correspondingly, the fiber array 70 may also be configured with 1×N receiving ports, thereby maintaining scalability of a system.

Through the above design, this embodiment not only achieves basic functional requirements of the transmitter structure, but also provides a simpler and more economical technical solution by adopting the optical mirror, thereby offering a new option for an industrial application of the silicon photonics module.

As shown in FIG. 5, an embodiment discloses the transmitter structure for the silicon photonics module. A main innovation of this embodiment is to use a first structural component 91 to combine the isolator 30 and the focusing lens 40 into an integrated assembly. This design not only improves an integration level of a device, but also enhances protection performance of optical components.

Specifically, the transmitter structure in this embodiment still includes the laser assembly 10, the collimating lens 20, the isolator 30, the focusing lens 40, the optical prism 50, the silicon photonics chip 60, and the fiber array 70 that are arranged sequentially along an optical path. A function of the collimating lens 20 is to collimate the laser beam emitted from the laser assembly 10, thereby enabling the beam to propagate as parallel light.

A core improvement of this embodiment lies in the introduction of the first structural component 91. This component is specially designed to accommodate and secure both the isolator 30 and the focusing lens 40. The first structural component 91 has following characteristics.

Firstly, dedicated mounting positions are respectively designed for the isolator 30 and the focusing lens 40, thereby ensuring accurate relative positioning between the two optical components.

Secondly, stable mechanical support is provided, thereby reducing an impact of external vibration on the optical components.

Thirdly, good sealing performance is achieved, thereby effectively preventing impurities such as dust from affecting performance of the optical components.

In terms of optical path design, this embodiment still adopts a non-collinear design scheme. An optical system is composed of the laser assembly 10, the collimating lens 20, and the optical components within the first structural component 91, and a preset angular deviation is provided between an optical axis of the optical system and a central axis of an input waveguide 61 of the silicon photonics chip 60. Precise optical path redirecting is achieved through the optical prism 50, thereby ensuring effective coupling with the input waveguide 61 of the silicon photonics chip 60.

The structure of the silicon photonics chip 60 remains unchanged, and still includes functional units such as the input waveguide 61, a beam splitter, a modulator, and an output waveguide 62 that are arranged sequentially along a direction of an optical path. Similarly, a quantity of ports at the output waveguide 62 of the silicon photonics chip 60 may be configured as 1×N output ports according to actual needs, and the corresponding fiber array 70 also supports a corresponding 1×N expanded configuration.

This embodiment, by adopting a combined design of the first structural component 91, offers following advantages.

Firstly, an assembly accuracy of the isolator and the focusing lens is improved.

Secondly, environmental adaptability of the optical components is enhanced.

Thirdly, an assembly process is simplified, and production efficiency is increased.

Fourthly, it is beneficial for long-term product reliability.

This improved structural design provides a more reliable technical solution for the transmitter structure for the silicon photonics module, especially suitable for application scenarios requiring high stability.

As shown in FIG. 6, an embodiment discloses the transmitter structure for the silicon photonics module. A main innovation of this embodiment is to use a second structural component 92 to combine the focusing lens 40 and the optical prism 50 into an integrated assembly. This design not only enhances an integrity of a device in this part, but also protects the optical components and simplifies a lens-coupling process of a device.

Specifically, the transmitter structure in this embodiment includes the laser assembly 10, the collimating lens 20, the isolator 30, a combined assembly consisting of the focusing lens 40 and the optical prism 50, the silicon photonics chip 60, and the fiber array 70 that are arranged sequentially along an optical path. The collimating lens 20 is used to collimate the laser beam emitted from the laser assembly 10, thereby enabling the beam to propagate as parallel light. The isolator 30 is used to control unidirectional transmission of the beam, thereby improving resistance of the assembly to back-reflection.

A core improvement of this embodiment lies in the introduction of the second structural component 92. This component is precisely designed to accommodate and secure both the focusing lens 40 and the optical prism 50. The second structural component 92 has following characteristics.

Firstly, precise alignment is achieved. Dedicated mounting positions are designed for the focusing lens 40 and the optical prism 50 to ensure precise optical path alignment between the two, thereby reducing assembly errors.

Secondly, integrated protection is achieved. The two optical components are encapsulated as a whole through the second structural component 92, so that interference from external factors such as dust and vibration on the optical components is effectively prevented.

Thirdly, passive arrangement is achieved. The combined assembly may be passively arranged without a need for additional adjustment mechanisms, thereby simplifying a lens-coupling process and improving assembly efficiency.

In terms of optical path design, this embodiment still adopts a non-collinear design scheme. An optical system is composed of the laser assembly 10, the collimating lens 20, the isolator 30, and the combined assembly, and a preset angular deviation is provided between an optical axis of the optical system and a central axis of an input waveguide 61 of the silicon photonics chip 60. Precise optical path redirecting is achieved through the optical prism 50, thereby ensuring good mode field matching between the emitted beam of the laser and the input waveguide 61 of the silicon photonics chip 60, thus significantly reducing an influence of reflected light.

An internal structure of the silicon photonics chip 60 remains unchanged, with functional units such as the input waveguide 61, a beam splitter, a modulator, and an output waveguide 62 that are arranged sequentially along a direction of an optical path. A quantity of ports at the output waveguide 62 of the silicon photonics chip 60 may be flexibly configured as 1×N output ports according to actual needs. Correspondingly, the fiber array 70 also supports 1×N expanded configuration.

Through the above design, this embodiment has following advantages.

Firstly, an integration level is improved. By combining the focusing lens 40 and the optical prism 50 into an integrated assembly, a structure of the optical path is simplified and compactness of a system is improved.

Secondly, stability is enhanced. The second structural component 92 provides stable mechanical support for the optical components, thereby reducing an impact of external vibration on the optical path.

Thirdly, assembly is simplified. The passively arranged combined assembly reduces assembly difficulty and improves production efficiency, thereby making it particularly suitable for large-scale industrial applications.

By introducing the combined design of the second structural component 92, this embodiment provides a more efficient and stable technical solution for the transmitter structure for the silicon photonics module, with broad application prospects.

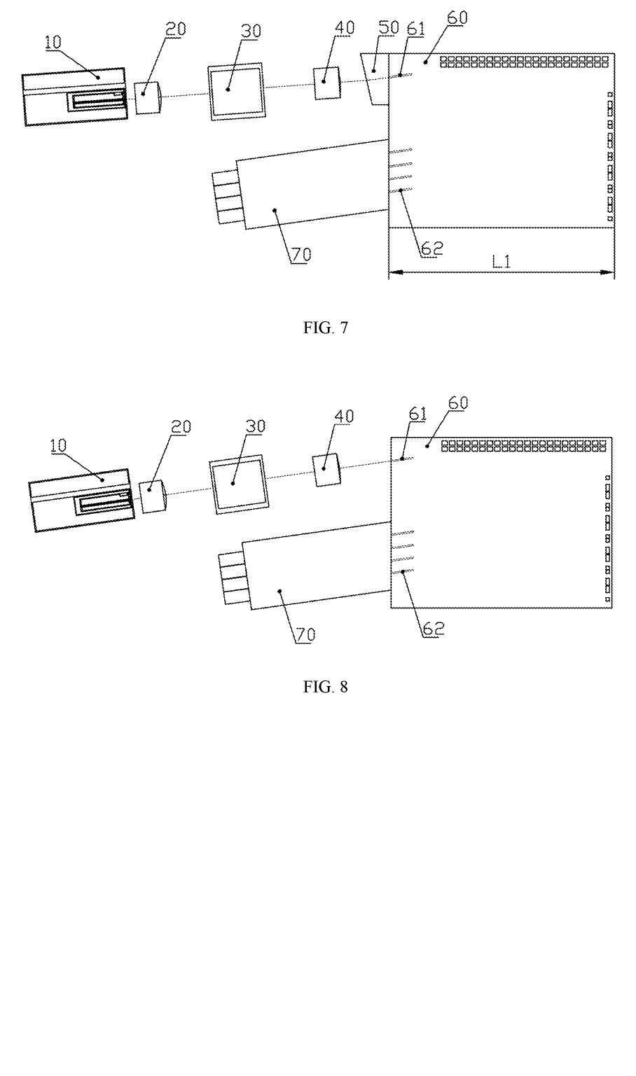

An embodiment discloses the transmitter structure for the silicon photonics module. As shown in FIG. 7, in this embodiment, when certain structural design requirements are met, an angle between a central axis of the optical input unit and a side L1 of the silicon photonics chip 60 is non‑zero. Depending on a beam deflection angle of different optical prisms 50, in order to solve a problem of refractive index change when the optical prism 50 couples light into the input waveguide 61, the angle between the central axis of the optical input unit and an input waveguide 61 may be zero or non‑zero. The isolator 30 may be disposed either in front of or behind the focusing lens 40.

An embodiment discloses the transmitter structure for the silicon photonics module. As shown in FIG. 8, in this embodiment, when certain structural design requirements are met, a structure in which a central axis of the optical input unit is collinear with an input waveguide 61 may also be adopted without using the optical prism 50. To solve a problem of refractive index change when light enters from a free space into the input waveguide 61, an angle between the central axis of the optical input unit and the input waveguide 61 may be non‑zero to achieve better mode field matching. The isolator 30 may be disposed either in front of or behind the focusing lens 40. This technical solution has advantages of simple structure and lower component cost, but imposes higher requirements on processes such as component mounting and coupling.

It should be pointed out that the lenses in the present disclosure may be made of any materials, including but not limited to silicon lenses, glass lenses, and plastic lenses; and the lenses may be of any shape, such as circular or square.

It should be understood that the sequence numbers of the steps in the above embodiments do not imply a particular order of execution. The execution order of processes should be determined by their functions and internal logic, and should not constitute any limitation on the implementation process of the embodiments of the present disclosure.

It should be understood that those of ordinary skill in the art may make improvements or modifications based on the above description, and all such improvements and modifications should fall within the protection scope of the claims appended to the present disclosure.

1. A transmitter structure, comprising a silicon photonics chip, the silicon photonics chip comprising at least one input waveguide, and an optical input unit being correspondingly arranged upstream of an optical path of each input waveguide, wherein a central optical axis of the optical input unit and a central optical axis of the input waveguide are arranged in a non-collinear layout, an optical redirecting device is arranged between the optical input unit and the silicon photonics chip, and the optical redirecting device is configured to receive a laser beam from the optical input unit and redirect the laser beam to the input waveguide.

2. The transmitter structure according to claim 1, wherein the optical redirecting device is an optical prism or an optical mirror.

3. The transmitter structure according to claim 2, wherein the optical input unit comprises a laser assembly, a collimating lens, a focusing lens, and an isolator that are arranged in sequence.

4. The transmitter structure according to claim 2, wherein the optical prism comprises an incident surface facing the optical input unit and an exit surface facing the input waveguide, and the incident surface and the exit surface are arranged non-parallel to each other.

5. The transmitter structure according to claim 4, wherein the optical input unit comprises a laser assembly, a collimating lens, a focusing lens, and an isolator that are arranged in sequence.

6. The transmitter structure according to claim 1, wherein the optical input unit comprises a laser assembly, a collimating lens, a focusing lens, and an isolator that are arranged in sequence.

7. The transmitter structure according to claim 6, comprising a first structural component, wherein an end of the first structural component is provided with an isolator mounting position, another end of the first structural component is provided with a focusing lens mounting position, the isolator mounting position and the focusing lens mounting position are interconnected, the isolator is mounted in the isolator mounting position, and the focusing lens is mounted in the focusing lens mounting position.

8. The transmitter structure according to claim 6, comprising a second structural component, wherein an end of the second structural component is provided with a focusing lens mounting position, another end of the second structural component is provided with an optical prism mounting position, the optical prism mounting position and the focusing lens mounting position are interconnected, the focusing lens is mounted in the focusing lens mounting position, and the optical prism is mounted in the optical prism mounting position.

9. The transmitter structure according to claim 1, wherein the central optical axis of the optical input unit is parallel to a long side of the silicon photonics chip, or an angle exists between the central optical axis of the optical input unit and a long side of the silicon photonics chip.

10. The transmitter structure according to claim 1, wherein the silicon photonics chip comprises at least one output waveguide, and a fiber array is correspondingly arranged downstream of an optical path of the output waveguide.

11. A silicon photonics module, comprising a transmitter structure, wherein the transmitter structure comprises a silicon photonics chip, the silicon photonics chip comprises at least one input waveguide, an optical input unit is correspondingly arranged upstream of an optical path of each input waveguide; and a central optical axis of the optical input unit and a central optical axis of the input waveguide are arranged in a non-collinear layout, an optical redirecting device is arranged between the optical input unit and the silicon photonics chip, and the optical redirecting device is configured to receive a laser beam from the optical input unit and redirect the laser beam to the input waveguide.

12. The silicon photonics module according to claim 11, wherein the optical redirecting device is an optical prism or an optical mirror.

13. The silicon photonics module according to claim 12, wherein the optical input unit comprises a laser assembly, a collimating lens, a focusing lens, and an isolator that are arranged in sequence.

14. The silicon photonics module according to claim 12, wherein the optical prism comprises an incident surface facing the optical input unit and an exit surface facing the input waveguide, and the incident surface and the exit surface are arranged non-parallel to each other.

15. The silicon photonics module according to claim 14, wherein the optical input unit comprises a laser assembly, a collimating lens, a focusing lens, and an isolator that are arranged in sequence.

16. The silicon photonics module according to claim 11, wherein the optical input unit comprises a laser assembly, a collimating lens, a focusing lens, and an isolator that are arranged in sequence.

17. The silicon photonics module according to claim 16, wherein the transmitter structure comprises a first structural component, an end of the first structural component is provided with an isolator mounting position, another end of the first structural component is provided with a focusing lens mounting position, the isolator mounting position and the focusing lens mounting position are interconnected, the isolator is mounted in the isolator mounting position, and the focusing lens is mounted in the focusing lens mounting position.

18. The silicon photonics module according to claim 16, wherein the transmitter structure comprises a second structural component, an end of the second structural component is provided with a focusing lens mounting position, another end of the second structural component is provided with an optical prism mounting position, the optical prism mounting position and the focusing lens mounting position are interconnected, the focusing lens is mounted in the focusing lens mounting position, and the optical prism is mounted in the optical prism mounting position.

19. The silicon photonics module according to claim 11, wherein the central optical axis of the optical input unit is parallel to a long side of the silicon photonics chip, or an angle exists between the central optical axis of the optical input unit and a long side of the silicon photonics chip.

20. The silicon photonics module according to claim 11, wherein the silicon photonics chip comprises at least one output waveguide, and a fiber array is correspondingly arranged downstream of an optical path of the output waveguide.
